(19) United States
(12) Patent Application Publication
(10) Pub. No.: US 2018/0102696 A1
(43) Pub. Date: Apr. 12, 2018

(54) ROTOR MANUFACTURING METHOD

(71) Applicant: HONDA MOTOR CO., LTD., Tokyo (JP)

(72) Inventors: Akikazu IWAMOTO, Saitama (JP); Keisuke AZUSAWA, Saitama (JP)

(73) Assignee: HONDA MOTOR CO., LTD., Tokyo (JP)

(21) Appl. No.: 15/725,618

(22) Filed: Oct. 5, 2017

(30) Foreign Application Priority Data
Oct. 6, 2016 (JP) 2016-198330

(51) Int. Cl. H02K 15/03; H02K 1/27

(52) U.S. Cl. CPC H02K 15/03; H02K 1/274

(57) ABSTRACT

In a rotor manufacturing method, two rotor cores (20) having magnet insertion holes (14) disposed with permanent magnets (40) are disposed opposite to each other with a middle die (110) interposed therebetween in a rotor core disposing step (S210), and resin is supplied to the two rotor cores (20) from the middle die (110) and the resin is filled between the magnet insertion hole (14) and the permanent magnet (40) in a resin filling step (S230). Therefore, it is possible to reduce the amount of cull which is a residual cured product of the resin.

### CROSS-REFERENCE TO RELATED APPLICATION

This application claims priority from Japanese Patent Application No. 2016-198330 filed on Oct. 6, 2016, the entire contents of which are incorporated herein by reference.

### TECHNICAL FIELD

The present invention relates to a rotor manufacturing method of manufacturing a rotor by fixing a permanent magnet to a rotor core.

### BACKGROUND ART

In the related art, a rotary electric machine used for a hybrid vehicle or the like is configured in which a rotor is rotatably supported inside a case. In a rotor core of the rotor, permanent magnets are fixed to a plurality of magnet insertion holes formed along a circumferential direction of the rotor core.

As one of a rotor manufacturing method of such a rotary electric. machine, a so-called resin injection method is known in which after the permanent magnets are inserted into the magnet insertion holes of the rotor core, resin is injected from resin grooves provided in the magnet insertion holes, and the resin is solidified to fix the permanent magnets (for example, patent literature 1).

As a method of injecting the resin into the resin grooves provided in the magnet insertion holes, as illustrated in FIG. 4, there is so-called transfer molding in which a rotor core 1 is disposed on a lower die 2, a gate die 3 is placed above the rotor core 1, and a resin tablet 5 is pressed by a plunger 6 in a state where an upper die 4 is placed above the gate die 3, whereby the resin is injected.

Here, the gate die 3 has gates 3a which are a plurality of resin flow channels formed radially as illustrated in FIG. 5, and a tip part of the gate 3a branches and continues to a plurality of resin injection holes 3c of a lower gate die 3b. The gate die 3 is configured to inject the resin of a resin tablet 5 located at a central part thereof to each of magnet insertion holes 1a from the resin injection holes 3c, as illustrated in FIG. 4.

As a step of injecting the resin in the transfer molding, first, permanent magnets 1b are inserted into the magnet insertion holes 1a of the rotor core 1 as illustrated in FIG. 6A, and the rotor core 1 is preheated as illustrated in FIG. 5B.

Subsequently, as illustrated in FIG. 6C, resin 5a is injected into the magnet insertion holes 1a through the resin injection holes 3c of the gate die 3 by pressing the resin tablet 5 with the plunger 6. Then, as illustrated in FIG. 6D, the resin 5a is heated and cured, and the resin 5a is cooled and solidified as illustrated in FIG. 6E, whereby the permanent magnets 1b are fixed to the magnet insertion hole 1a.

### RELATED ART LITERATURE

### Patent Literature

Patent Literature 1: JP-A-20013-219992

### SUMMARY OF THE INVENTION

### Problem that the Invention is to Solve

However, when the resin 5a is injected by the transfer molding described above, extra resin called cull, which is a residual cured product of the resin 5a having substantially the same shape as that of the gate 3a, remains in the gate 3a of the gate die 3, so there is a problem that the production yield is reduced.

The invention has been made in view of the above problems, and an object thereof is to provide a rotor manufacturing method capable of reducing the amount of cull which is a residual cured product of resin.

### Means for Solving the Problem

In order to achieve the above object, according to an invention of aspect 1, there is a rotor manufacturing method, including the steps of:

disposing (for example, rotor core disposing step S210 in an embodiment) two rotor cores (for example, rotor cores 20 in an embodiment) opposite to each other with a resin filling die (for example, a middle die 110 in an embodiment) interposed therebetween, the two rotor cores having magnet insertion holes (for example, magnet insertion holes 14 in an embodiment) in which magnets (for example, permanent magnets 40 in an embodiment) are disposed; and

supplying (for example, resin filling step S230 in an embodiment) the two rotor cores with resin from the resin filling die to fill the resin between the magnet insertion hole and the magnet.

According to an invention of aspect 2, in the invention of aspect 1, in the step of filling the resin, the resin is simultaneously supplied to the two rotor cores.

According to an invention of aspect 3, in the invention of aspect 1, in the step of filling the resin, the resin is supplied to the two rotor cores by pressing a resin tablet (for example, a resin tablet 140 in an embodiment) with a plunger (for example, a plunger 150 in an embodiment).

According to an invention of aspect 4, in the invention of aspect 3, the resin tablet is disposed in a shaft hole (for example, a shaft hole 11a in an embodiment) provided in a central part of either of the two rotor cores.

According to an invention of aspect 5, in the invention of aspect 1, the resin filling die includes a first die (for example, an upper plate 102 in an embodiment) which is in contact with one of the two rotor cores, a second die (for example, a lower plate 103 in an embodiment) which is in contact with the other rotor core, and a third die (for example, a middle plate 101 in an embodiment), where a channel is formed, which is disposed between the first die and the second die.

According to an invention of aspect 6, in the invention of aspect 5, the first die is provided with a cylindrical cylinder (for example, a cylinder 102a in an embodiment) which is provided in a shaft hole (for example, the shaft hole 11a in an embodiment) provided in a central part of the one rotor core, and

a plunger is slidably disposed inside the cylinder.

According to an invention of aspect 7, in the invention of aspect 6, in the step of disposing the rotor cores, the one rotor core is disposed between the first die of the resin filling die and an upper die (for example, an upper die 120 in an embodiment), and the other rotor core is disposed between the second die of the resin filling die and a lower die (for example, a lower die 130 in an embodiment), and

the upper die is provided with a plunger insertion hole (for example, a plunger insertion hole 121 in an embodiment) through which the plunger is inserted.

### Advantage of the Invention

According to the invention of aspect 1, the resin is supplied to the rotor cores disposed opposite to each other, and the resin is filled between the magnet insertion hole and the magnet, so that it is also possible to halve the amount of cull which is a residual cured product of the resin.

According to the invention of aspect 2, in the resin filling step, since the resin is simultaneously supplied to two rotor cores, the manufacturing time can be shortened by half corn pared with the rotor manufacturing method according to the related art in which the resin is filled in each rotor core.

According to the invention of aspect 3, since so-called transfer molding is adopted in which the resin tablet is pressed by the plunger, the injection pressure can be set to be lower compared with injection molding.

According to the invention of aspect 4, the resin tablet is disposed in the shaft hole provided in the central part of the two rotor cores, so that it is possible to simultaneously supply the resin to each of the magnet insertion holes located substantially at an equal distance from the central part of the rotor core.

According to the invention of aspect 5, since the resin filling die includes the first to third dies, it is possible to easily remove cull remaining in the channel.

According to the invention of aspects 6 and 7, it is possible to easily control the injection pressure compared with the case of being pressed from both sides by the plunger.

### BRIEF DESCRIPTION OF DRAWINGS

FIG. 1 is a perspective view of a rotor used in a rotor manufacturing method according to an embodiment of the invention.

FIG. 2 is a partial sectional view illustrating a transfer molding die used in the rotor manufacturing method according to an embodiment of the invention.

FIG. 3 is a flowchart of the rotor manufacturing method according to an embodiment of the invention.

FIG. 4 is a partial sectional view of a transfer molding die used in a rotor manufacturing method according to the related art.

FIG. 5 is a plan view illustrating a gate die used in the rotor manufacturing method according to the related art.

FIGS. 6A to 6E are explanatory diagrams illustrating steps of the rotor manufacturing method according to the related art.

### MODE FOR CARRYING OUT THE INVENTION

A rotor manufacturing method according to an embodiment of the invention will be described below with reference to the accompanying drawings. Note that the drawings are to be seen in a direction in which reference numerals given therein look normal.

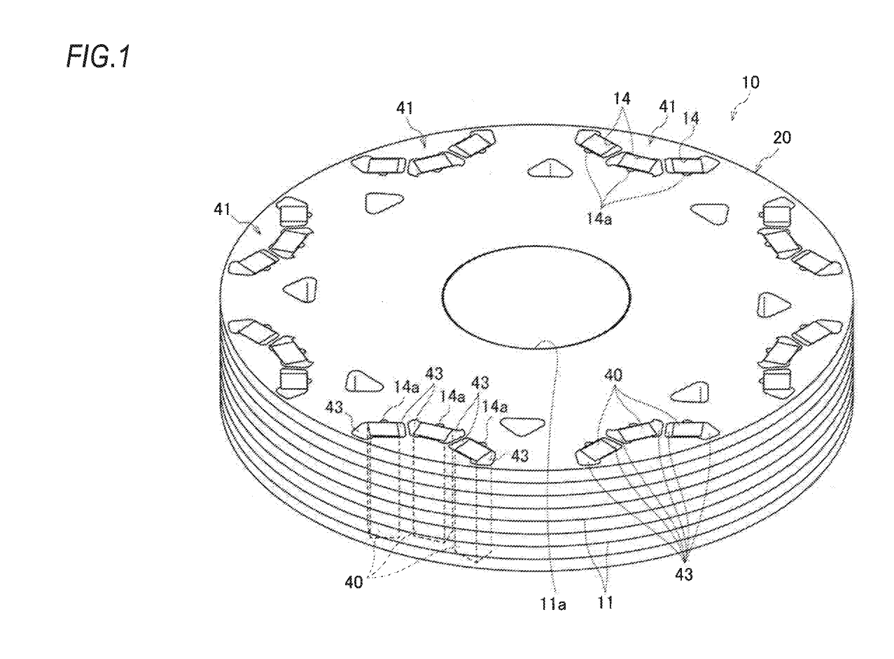

First, a rotor core used in the rotor manufacturing method according to the embodiment of the invention will be described with reference to FIG. 1.

A so-called permanent magnet embedded rotor 10 used for a rotary electric machine generally includes a rotor core 20, a plurality of permanent magnets 40, and a resin portion 43 for fixing the permanent magnets 40 to the rotor core 20.

The rotor core 20 is constituted by stacking a plurality of electromagnetic steel sheets 11 having substantially an annular shape, and has a shaft hole 11a at the center thereof and a plurality of magnet insertion holes 14 at an outer peripheral portion thereof In the example illustrated in FIG. 1, three magnet insertion holes 14 constitute one magnetic pole 41.

Each of the magnet insertion holes 14 is provided with a resin groove 14a extending in an axial direction along the magnet insertion hole 14, and resin flows in from the resin groove 14a by transfer molding to be described below, whereby the permanent magnet 40 is fixed.

The three magnet insertion holes 14 constituting one magnetic pole 41 are disposed such that two magnet insertion holes 14 located on both sides are opened to an outer diameter side in a V shape with respect to the magnet insertion hole 14 located at the center. The magnet insertion holes 14 are opened in the axial direction, and are independent from each other.

In the three magnet insertion holes 14 constituting one magnetic pole 41, the permanent magnets 40 having the same magnetization direction are disposed. In the magnetic poles 41 adjacent to each other in a circumferential direction, permanent magnets 40 different in magnetization direction from the above permanent magnets 40 are disposed, so that magnetic poles are alternately inverted in the circumferential direction.

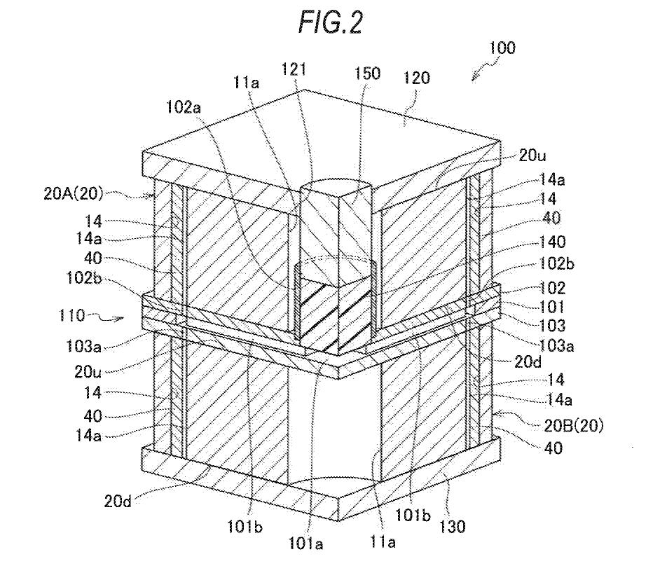

A transfer molding die used in the rotor manufacturing method according to the embodiment will be described below with reference to FIG. 2.

A transfer molding die 100 is made up of a middle die 110, an upper die 120, and a lower die 130, two rotor cores 20 (hereinafter, the rotor core 20 located at an upper side may be referred to as a first rotor core 20A, and the rotor core 20 located at a lower side may be referred to as a second rotor core 20B) are vertically disposed opposite to each other with the middle die 110 interposed therebetween, and the upper die 120 and the lower die 130 are disposed on an upper part and a lower part of the two rotor cores 20, respectively.

The upper die 120 is formed in a rectangular flat plate shape, and functions to close an upper end of the magnet insertion hole 14 formed in the first rotor core 20A by coming in contact with an upper surface 20u of the first rotor core 20A. A central part of the upper die 120 is formed with a plunger insertion hole 121 through which a plunger 150 is inserted.

The lower die 130 is formed in a rectangular flat plate shape, and functions to close a lower end of the magnet insertion hole 14 formed in the second rotor core 20B by coming in contact with a lower surface 20d of the second rotor core 20B.

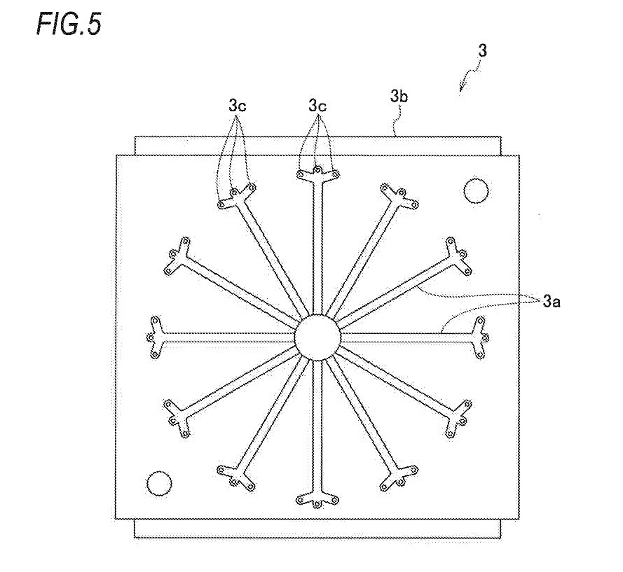

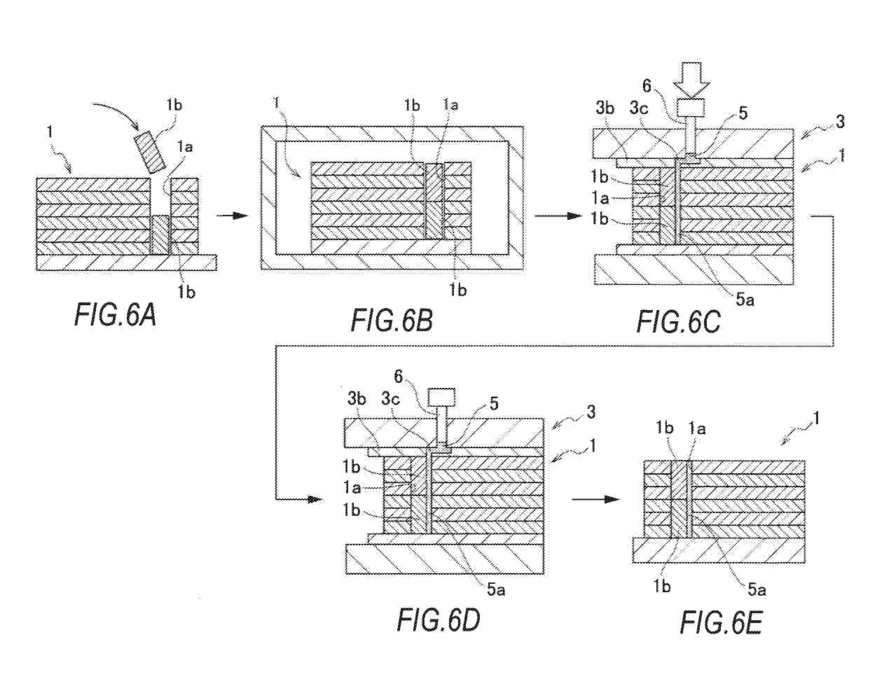

The middle die 110 includes a middle plate 101, an upper plate 102, and a lower plate 103. A columnar tablet arranging portion 101a disposed with a resin tablet 140 is formed at a central part of the middle plate 101, and a plurality of gates 101b extend radially toward the magnetic pole 41 from the tablet arranging portion 101a, the gate serving as a resin flow channel. A branching portion (see FIG. 5) is formed at a tip part of the gate 10th so as to extend into the resin groove 14a of the three magnet insertion hole 14 constituting the magnetic pole 41.

The upper plate 102 is formed in a rectangular flat plate shape, and functions to close a lower end of the magnet insertion hole 14 formed in the first rotor core 20A by coming in contact with a lower surface 20d of the first rotor core 20A. At the central part of the upper plate 102, a cylindrical cylinder 102a is provided coaxially with the plunger insertion hole 121 of the upper die 120 and inside the shaft hole 11a provided at the central part of the first rotor core 20A, and the plunger 150 is slidably disposed inside the cylinder 102a.

In addition, a plurality of resin injection holes 102b are formed to extend in the axial direction at positions of the upper plate 102 corresponding to the resin grooves 14a of the magnet insertion holes 14 in the first rotor core 20A, and guide the resin supplied from the gates 101b of the middle plate 101 to the resin grooves 14a of the first rotor core 20A.

The lower plate 103 is formed in a rectangular flat plate shape, and functions to close the upper end of the magnet insertion hole 14 formed in the second rotor core 20B by coming in contact with the upper surface 20u of the second rotor core 20B. A plurality of resin injection hole 103a are formed to extend in the axial direction at positions of the lower plate 103 corresponding to the resin grooves 14a of the magnet insertion holes 14 in the second rotor core 203, and guide the resin supplied from the gates 101b of the middle plate 101 to the resin grooves 14a of the second rotor core 20B.

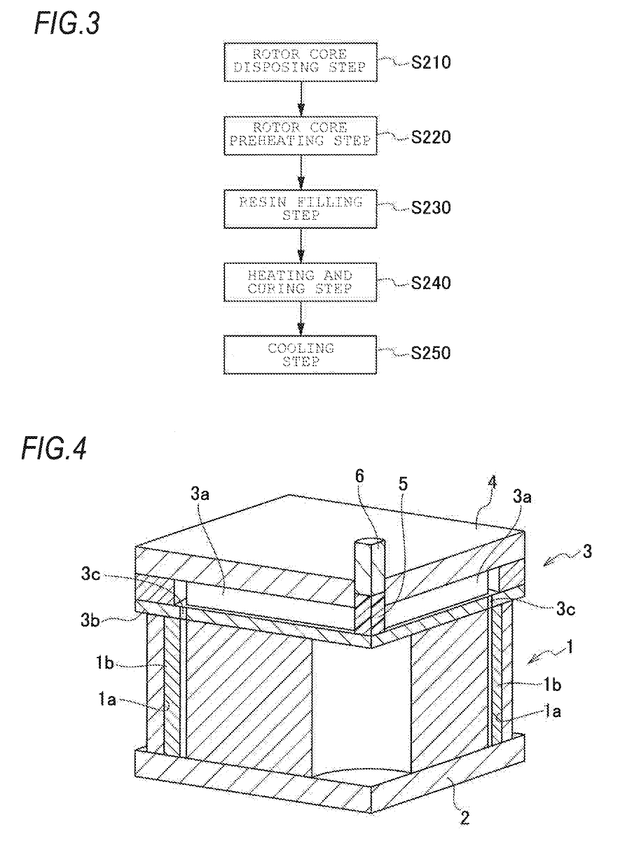

The rotor manufacturing method according to the embodiment will be described below with reference to a flowchart of FIG. 3.

In rotor core disposing step S210, first, the second rotor core 20B is disposed on the lower die 130, and the permanent magnet 40 is inserted into the magnet insertion hole 14 of the second rotor core 20B.

Subsequently, the first rotor core 20A and the second rotor core 20B are disposed opposite to each other in the vertical direction with the middle die 110 interposed therebetween, and the permanent magnet 40 is inserted into the magnet insertion hole 14 of the first rotor core 20A. Thereafter, the upper die 120 is disposed on the first rotor core 20A.

In this way, as illustrated in FIG. 2, the lower die 130, the second rotor core 20B, the lower plate 103, the middle plate 101, the upper plate 102, the first rotor core 20A, and the upper die 120 are stacked in this order from the bottom.

Subsequently, in rotor core preheating step S220, the first rotor core 20A and the second rotor core 20B each having the magnet insertion holes 14, into which the permanent magnet 40 is inserted, are preheated together with the transfer molding die 100.

In resin filling step S230, as a preparatory step, the resin tablet 140 for one shot is inserted from the plunger insertion hole 121 of the upper die 120 into the shaft hole 11a of the first rotor core 20A, further passes through the cylinder 102a of the upper plate 102, and is disposed on the tablet arranging portion 101a of the middle plate 101.

Similarly, the plunger 150 is inserted from the plunger insertion hole 121 of the upper die 120 into the shaft hole 11a of the upper rotor core 20, further passes through the cylinder 102a of the upper plate 102, and is brought into contact with the resin tablet 140.

Then, the plunger 150 is pressed downward. Thus, the resin tablet 140 is pressurized by the plunged 50 in the cylinder 102a of the upper plate 102.

By the pressurization of the resin tablet 140, the resin passes through the plurality of gates 101b from the tablet arranging portion 101a of the middle plate 101 and branches above and below, and the branched resins passes through the resin injection hole 102b of the upper plate 102 and the resin injection hole 103a of the lower plate 103 to be injected into the resin grooves 14a of the first rotor core 20A and the second rotor core 20B, respectively, and are filled between the magnet insertion hole 14 and the permanent magnet 40.

In heating and curing step S240, the first rotor core 20A and the second rotor core 20B filled with the resin in resin filling step S230 are heated together with the transfer molding die 100 by a heating furnace, for example. Therefore, the resin filled between the magnet insertion hole 14 and the permanent magnet 40 is cured.

Finally, in cooling step S250, the first rotor core 20A and the second rotor core 20B are cooled down together with the transfer molding die 100 by a cooling furnace, for example. Therefore, the permanent magnet 40 is firmly fixed to the magnet insertion hole 14 of the rotor core 20. In cooling step S250, only the first rotor core 20A and the second rotor core 20B may be cooled excluding the transfer molding die 100, and the cooling by natural heat radiation may be performed instead of the cooling by the cooling furnace.

As described above, according to the embodiment, the first rotor core 20A and the second rotor core 20B, in which the permanent magnet 40 is disposed in the magnet insertion hole 14, are disposed opposite to each other with the middle die 110 interposed therebetween in rotor core disposing step S210; and the resin is supplied to the first rotor core 20A and the second rotor core 20B from the middle die 110, thereby filling the resin between the magnet insertion hole 14 and the permanent magnet 40 in resin filling step S230.

Therefore, it is possible to simultaneously supply the resin to the first rotor core 20A and the second rotor core 20B disposed opposite to each other with one middle die 110, and the amount of cull being a residual cured product remaining in the middle plate 101 is equal to the amount of cull generated at the time of manufacturing one rotor core 20 in the related art. That is, since the amount of cull generated at the time of manufacturing two rotor cores 20 is equal to the amount of cull generated at the time of manufacturing one rotor core 20 in the related art, it is possible to halve the amount of cull generated in each rotor core 20 compared with the related art and improve the production yield.

In resin filling step S230, since the resin is simultaneously supplied to two rotor cores 20, the manufacturing time can be shortened by half compared with the rotor manufacturing method according to the related art in which the resin is filled in each rotor core 20.

In resin filling step S230, since so-called transfer molding is adopted in which the resin tablet 140 is pressed by the plunger 150 and thus the resin is supplied to the first rotor core 20A and the second rotor core 20B, the injection pressure can be set to be lower compared with injection molding.

Further, the resin tablet 140 is disposed in the shaft hole 11a provided in the central part of the first rotor core 20A of two rotor cores 20. Therefore, it is possible to simultaneously supply the resin to each of the magnet insertion holes 14 located substantially at an equal distance from the central part of the rotor core 20.

In addition, since the middle die 110 includes the upper plate 102 which is in contact with the first rotor core 20A, the lower plate 103 which is in contact with the second rotor core 20B, and the middle plate 101, where the channel is formed, which is disposed between the upper plate 102 and the lower plate 103, it is possible to easily remove the amount of cull remaining in the channel of the middle plate 101.

In the upper plate 102, the cylindrical cylinder 102a is provided in the shaft hole 11a provided in the central part of the first rotor core 20A, and the plunger 150 is slidably disposed inside the cylinder 102a, whereby it is possible to easily control the injection pressure compared with the case of being pressed from both sides by the plunger 150.

In rotor core disposing step S210, the first rotor core 20A is disposed between the upper plate 102 of the middle die 110 and the upper die 120, the second rotor core 208 is disposed between the lower plate 103 of the middle die 110 and the lower die 130, and the upper die 120 is provided with the plunger insertion hole 121 through which the plunger 150 is inserted, whereby it is possible to easily control the injection pressure compared with the case of being pressed from both sides by the plunger 150.

It should be noted that the present invention is not limited to the above-described embodiment, but can be modified and improved as appropriate.

For example, the transfer molding using the transfer molding die 100 is used in the embodiment, but another molding method such as injection molding is also applicable to the present invention without being limited thereto.

### DESCRIPTION OF REFERENCE NUMERALS AND CHARACTERS

11a shaft hole
14 magnet insertion hole
20 rotor core
40 permanent magnet (magnet)
101 middle plate (third die)
102 upper plate (first die)
102a cylinder
103 lower plate (second die)
110 middle die (resin filling die)
120 upper die
121 plunger insertion hole
130 lower die
140 resin tablet
150 plunger
S210 rotor core disposing step
S230 resin filling step

1. A rotor manufacturing method, comprising the steps of:
disposing two rotor cores opposite to each other with a resin filling die interposed therebetween, the two rotor cores having magnet insertion holes in which magnets are disposed; and
supplying the two rotor cores with resin from the resin filling die to fill the resin between the magnet insertion hole and the magnet.

2. The rotor manufacturing method according to claim 1,
wherein in the step of filling the resin, the resin is simultaneously supplied to the two rotor cores.

3. The rotor manufacturing method according to claim 1,
wherein in the step of filling the resin, the resin is supplied to the two rotor cores by pressing a resin tablet with a plunger.

4. The rotor manufacturing method according to claim 3,
wherein the resin tablet is disposed in a shaft hole provided in a central part of either of the two rotor cores.

5. The rotor manufacturing method according to claim 1,
wherein the resin filling die includes a first die which is in contact with one of the two rotor cores, a second die which is in contact with the other rotor core, and a third die, where a channel is formed, which is disposed between the first die and the second die.

6. The rotor manufacturing method according to claim 5,
wherein the first die is provided with a cylindrical cylinder which is provided in a shaft hole provided in a central part of the one rotor core, and
a plunger is slidably disposed inside the cylinder.

7. The rotor manufacturing method according to claim 6,
wherein in the step of disposing the rotor cores, the one rotor core is disposed between the first die of the resin filling die and an upper die, and the other rotor core is disposed between the second die of the resin tilling die and a lower die, and
the upper die is provided with a plunger insertion hole through which the plunger is inserted.
